(19) United States
(12) Patent Application Publication
(10) Pub. No.: US 2025/0161871 A1
(43) Pub. Date: May 22, 2025

(54) Method and device for treating primary gas from a metallurgical vessel

(71) Applicant: SMS group GmbH, Mönchengladbach (DE)

(72) Inventor: Thilo WÜBBELS, Papenburg (DE)

(73) Assignee: SMS group GmbH, Mönchengladbach (DE)

(21) Appl. No.: 18/838,525

(22) PCT Filed: Feb. 13, 2023
(86) PCT No.: PCT/EP2023/053465

§ 371 Date: Aug. 14, 2024

(30) Foreign Application Priority Data
Feb. 16, 2022 (DE) 10 2022 201 570.3

(51) Int. Cl. B01D 53/56; B01D 53/86

(52) U.S. Cl. CPC B01D 53/56; B01D 53/8625; B01D 2251/2062; B01D 2251/2067; B01D 2253/102; B01D 2257/702; B01D 2258/025

(57) ABSTRACT

A method and a device serve for treating primary gas from a metallurgical vessel for the effective reduction of NOx constituents. The primary gas is supplied with a reducing agent. Additionally, secondary gas is suctioned at an auxiliary suction point in the surroundings of the metallurgical vessel. The primary gas is mixed with the colder secondary gas to produce a gas mixture. Thereby NOx constituents in the primary gas are effectively reduced without an undesired reactive influence on the process within the metallurgical furnace and without requiring high investment costs. This is achieved in that the primary gas is mixed with the secondary gas prior to supplying the reducing agent, namely such that the gas mixture is cooled to a temperature ranging from 400° C. to 600° C. prior to supplying the reducing agent, and the reducing agent is then supplied to the gas mixture, containing the primary gas.

### CROSS-REFERENCE TO RELATED APPLICATION

This application is a national stage application, filed under 35 U.S.C. § 371, of International Patent Application PCT/EP2023/053465, filed on Feb. 13, 2023, which claims the benefit of German Patent Application DE 10 2022 201 570.3, filed on Feb. 16, 2022.

### TECHNICAL FIELD

The disclosure relates to a method and a device for treating primary gas from a metallurgical vessel for the effective reduction of NOx constituents. The metallurgical vessel in accordance with the invention is, for example, an electric arc furnace, a reduction furnace or an induction furnace, each of which is suitable for the production of steel, ferrous alloys or non-ferrous metal alloys.

### BACKGROUND

In the prior art, it is common practice to initially cool so-called “primary gas,” which is produced during the operation of a metallurgical vessel, in particular a metallurgical furnace, and then to mix it with so-called “secondary gas,” which is extracted from the surroundings of the metallurgical vessel via a roof hood, for example, in order to produce a gas mixture. The resulting gas mixture is then supplied to a fabric filter, in particular in order to be cleaned of dust particles. The gas mixture is checked with regard to its NOx constituents. If the NOx content is too high, the following methods are known to reduce it:
1. It is possible to reduce the formation of NOx within the furnace, for example by using coal with a low nitrogen content, by minimizing the suctioning of ambient air into the furnace or by covering the arc with foam slag, etc. These measures serve to reduce the NOx content, but not to the extent recently desired.
2. SNCR (selective non-catalytic reduction): Injection of ammonia NH₃ or urea at a predefined temperature into a post-combustion chamber to treat the primary gas. Typically, however, the temperature in the post-combustion chamber is too low for an effective reduction of the NOx contents. Reheating would then be necessary, which in turn would be associated with increased costs and additional undesirable CO₂ emissions.
3. SCR (selective catalytic reduction): It is possible to retrofit a catalytic converter downstream of the fabric filter. However, the temperature there is often too low for a catalytic reaction. Here as well, additional heating would then be required, with the undesirable side effects mentioned above. In addition, of course, there would also be the investment costs for the catalytic converter.

The international patent application WO 2018/104169 A1 discloses a method and a device for reducing NOx in exhaust gas flows of metallurgical vessels and furnaces. Specifically, the application discloses a metallurgical vessel in the form of an electric arc furnace that generates primary gas during operation. The primary gas is directed into an exhaust gas line via a manifold and a manifold gap to suction oxygen from the surroundings. Inside the manifold, i.e. immediately after leaving the metallurgical vessel, urea is injected into the primary gas before the primary gas enriched with urea passes through an exhaust gas flow heater and is then enriched with said oxygen. The exhaust gas flow heater is designed in such a way that it heats the primary gas flow with the injected urea to a temperature between 400° C. and 1,000° C., preferably between 600° C. and 800° C.

The exhaust gas treated in this way is supplied to a coarse separator via the exhaust gas line before water is thereafter added to it. After the supply of water, the treated primary gas is mixed with secondary gas suctioned from the surroundings of the metallurgical vessel. The resulting gas mixture is then filtered before being dissipated into the surroundings.

With the method disclosed in the international application WO 2018/104169 A1, the urea injection and the heating of the exhaust gas take place, as mentioned, in the immediate vicinity of the metallurgical vessel. This can have the disadvantage that said measures have undesirable effects on the process in the metallurgical vessel. In addition, the provision of the exhaust gas flow heater is associated with high costs.

### SUMMARY

The invention is based on the object of further developing a known method and a known device for reducing nitrogen oxides in the primary gas of a metallurgical vessel, in particular a metallurgical furnace, in such a way that the NOx constituents can be reduced, without the measures required for this having an undesirable influence on the process within the metallurgical furnace and without high investment costs being required for this.

This object is achieved in terms of process engineering by the method as disclosed herein. This method is characterized in that the mixing of the primary gas to form the gas mixture is effected in a controlled manner only with a branched-off part of the secondary gas until the gas mixture has cooled to a temperature in the temperature range from 400° C. to 600° C.; and in that the reducing agent is supplied to the gas mixture containing the primary gas.

The present invention is based on the assumption that the primary gas initially has too high a temperature after exiting the metallurgical vessel in order to be able to carry out a meaningful reduction of the nitrogen oxides. Therefore, in accordance with the method in accordance with the invention, the claimed cooling is provided. In accordance with the invention, this cooling is effected particularly cost-effectively, namely by simply mixing the still hot primary gas with the significantly colder secondary gas suctioned from the surroundings. The supply of the secondary gas is effected until the resulting gas mixture has a temperature in the claimed temperature range of 400° C. to 600° C.

The term “claimed temperature from the temperature range . . . ” can mean, on the one hand, that the temperature of the gas mixture is controlled with an open loop (without feedback of the measured variable) or controlled with a closed loop (with feedback of the measured variable) to a specific temperature from the temperature range. On the other hand, this term can mean that the temperature of the gas mixture may fluctuate within the temperature range and that countermeasures are only taken if the temperature falls below the lower range limit and exceeds the upper range limit in the sense of two-point closed-loop control.

The abbreviation NOx means nitrogen oxide.

The claimed mixing process of the primary gas with the secondary gas can advantageously be implemented particularly inexpensively by simply implementing the necessary mixing device in the form of a node of the exhaust gas line for the primary gas and the exhaust gas line for the branched-off part of the secondary gas. A simple, suitably driven bypass valve can preferably serve as the necessary actuating body. In accordance with the invention, the actuating element is driven in such a way that it meters the partial quantity of the suctioned secondary gas, which is supplied to the primary gas, in such a way that the gas mixture has the desired temperature from the temperature range of 400° C. to 600° C.

In accordance with the invention, the injection of the reducing agent for reducing the nitrogen oxide content is not effected in the pure primary gas, but in the gas mixture of primary gas and secondary gas produced in accordance with the invention.

The supply of the reducing agent to the gas mixture in accordance with the invention is effected at such a great distance from the metallurgical vessel that any reaction to the processes taking place in the metallurgical vessel can be ruled out.

In accordance with a first exemplary embodiment of the method in accordance with the invention, the supply of the secondary gas to the warmer primary gas can be carried out either in the form of an open-loop control or in the form of a closed-loop control. When an open-loop control is carried out, the supplied partial quantity of suctioned secondary gas is adjusted so that the temperature of the gas mixture is within the claimed temperature range. With the open-loop control, a feedback of the actual temperature of the gas mixture is not effected for control purposes. This is the difference with a closed-loop control, with which the actual temperature of the gas mixture is preferably measured continuously during an ongoing metallurgical process and compared with a specified target temperature from the temperature range of 400° C. to 600° C. If an unacceptably large deviation of the actual temperature from the desired target temperature is detected, the first partial quantity of the suctioned secondary gas supplied to the gas mixture is varied accordingly

Alternatively or additionally, the amount of primary gas supplied could also be varied with the aid of a primary gas control valve; however, this would possibly have a detrimental effect on the process in the metallurgical vessel.

In accordance with a further embodiment of the invention, the primary gas is initially post-combusted in a post-combustion chamber after leaving the metallurgical vessel, but prior to its mixing with the secondary gas, in order to advantageously reduce the carbon content in particular. In particular, if such post-combustion is effected, the temperature of the primary gas rises significantly above the temperature that would be required for effective nitrogen oxide reduction by supplying the reducing agent. In this case in particular, the claimed cooling by adding parts of the secondary gas with the primary gas is required.

However, in particular in the case of post-combusting, the temperature of the primary gas can be so high that cooling by adding the secondary gas alone is not sufficient. In this case, the post-combustion primary gas is cooled to a temperature of 850° C. to 750° C. in a cooling chamber prior to its mixing with the secondary gas.

A further advantage of the claimed mixing process of the primary gas with the secondary gas is that the negative pressure of the primary gas, which is higher than the negative pressure of the secondary gas, is equalized and the resulting negative pressure of the gas mixture is lower than the negative pressure of the primary gas prior to mixing. This has the advantage that the filters and blowers then used to treat the gas mixture can be designed for lower pressures and can therefore be procured more cost-effectively than devices for higher pressures.

The secondary gas typically has a temperature of 50° C. to 80° C. prior to its mixing with the primary gas. Compared to the temperature of the primary gas prior to the mixing process, this temperature of the secondary gas is comparatively low. This has the advantage that effective cooling of the primary gas/the gas mixture resulting from the mixing process to the desired temperature range can be achieved with the claimed mixing process.

In accordance with a further exemplary embodiment, a hot gas cyclone can be provided between the cooling chamber and the claimed mixing device for mixing the primary gas with the secondary gas. The advantage of the hot gas cyclone is that it cleans the primary gas of coarse dust particles and at the same time reduces the pressure of the primary gas.

For accelerating the reduction of nitrogen oxides by the supplied reducing agent, it is advantageous if the gas enriched with the reducing agent is passed through a hot gas filter. The hot gas filter contains catalyst-coated candles, wherein the coating acts as a catalyst for the desired NOx reduction and the candles act as dust separators.

Finally, the cleaned and NOx-reduced gas mixture is suctioned at the outlet of the hot gas filter device with the aid of an induced draft blower and discharged into the surroundings through a chimney. Due to the reduced temperature and pressure of the gas mixture, the induced draft blower can be designed to be comparatively cost-effective.

The method in accordance with the invention advantageously provides that, in principle, the primary gas and the secondary gas are treated separately, in particular cleaned, before such gases are released into the surroundings via the chimney. Specifically, in accordance with a further exemplary embodiment, the method in accordance with the invention provides that a further partial quantity of the suctioned secondary gas, which is not mixed with the primary gas, is cleaned in a filtering separator, in particular in a dust-reducing manner, before it is discharged through the chimney. The filtering separator for the secondary gas can be designed to be more cost-effective than the hot gas separator for the gas mixture, because the pressure and temperature of the secondary gas to be cleaned are significantly lower than the pressure and temperature of the gas mixture to be cleaned by the hot gas filter device.

In both filters, i.e. both in the filtering separator for the secondary gas and in the hot gas filter device for the gas mixture, activated carbon can advantageously be used to remove furan and dioxins from the gases.

In accordance with a further exemplary embodiment, it is provided that at least a part of the further partial quantity of the cleaned, in particular dedusted secondary gas is supplied to the NOx-reduced and dedusted gas mixture, in order to generate a residual gas mixture that has an even lower temperature and an even lower pressure than the gas mixture after leaving the hot gas filter. The lower pressure and the lower temperature of the residual gas mixture in turn enable a more cost-effective design of the induced draft blower.

This cooling of the gas mixture can also be effected in the form of open-loop or closed-loop control, as described above. A cost-effective additional bypass valve can also be used here as an actuating element.

With the method in accordance with the invention, urea or ammonia is used in particular as a reducing agent for reducing the nitrogen oxide content in the primary gas.

The above-mentioned object is further achieved by the device as disclosed. The advantages of this device and of the configurations discussed in the further dependent device claims correspond to the advantages mentioned above with reference to the claimed method.

### BRIEF DESCRIPTION OF THE DRAWINGS

The invention is accompanied by a single FIGURE, which illustrates the device in accordance with the invention.

### DETAILED DESCRIPTION

The invention is described in detail below with reference to this FIGURE with various exemplary embodiments.

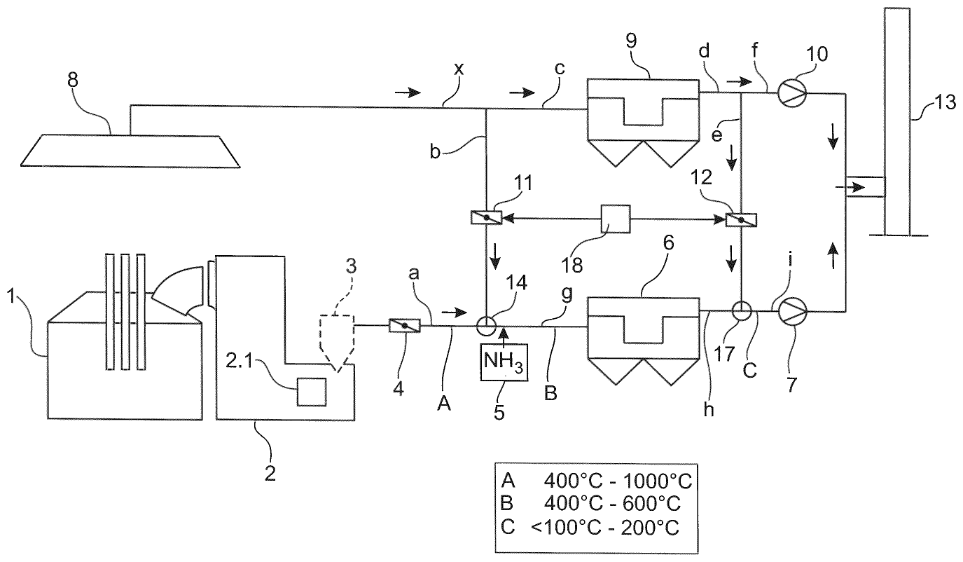

FIG. 1 illustrates the device in accordance with the invention. It comprises all components that are arranged between a metallurgical vessel 1, in particular a metallurgical furnace, and a chimney 13. The metallurgical vessel 1 and the chimney 13 themselves are not part of the device in accordance with the invention.

The device comprises a post-combustion chamber 2 downstream of the metallurgical vessel 1, which can also provide a means of utilizing the waste heat generated therein. A cooling device 2.1 can be provided inside or downstream of the post-combustion chamber 2 for pre-cooling the primary gas to a temperature of typically 850° C. to 750° C. A hot gas cyclone 3 for separating dust particles and reducing the pressure in the primary gas is optionally installed downstream of the cooling chamber 2.1. Downstream of the hot cyclone is a first actuating element 4, for example a primary gas control valve for the closed-loop control of the volume flow of the primary gas in the exhaust gas line a for the primary gas.

Independent of the primary gas branch a just described, a secondary gas branch x runs, which starts at an auxiliary suction point 8, for example a roof hood, with the aid of which air—and thus oxygen—are extracted from the surroundings of the metallurgical vessel 1. This air is also referred to as secondary gas. Extraction is effected with the aid of a secondary gas induced draft blower 10. A filtering separator 9 for dedusting from the secondary gas is provided in a line c between the auxiliary suction point 8 and the secondary gas induced draft blower 10 for a further partial quantity of the suctioned secondary gas. With the aid of the induced draft blower 10, the residual secondary gas is released into the surroundings via the chimney 13.

In the drawing, a first branch b, also known as a bypass or line for a part (partial quantity) of the suctioned secondary gas, is provided for connecting the secondary gas line x to the primary gas line a. A first actuating element 11, for example in the form of a first bypass valve, is installed in this first branch b. Where the first branch b and the primary gas line a meet, the claimed mixing process of the primary gas and the branched-off partial quantity of the secondary gas takes place. In this respect, this node point is also referred to as mixing device 14 within the meaning of the invention. The said mixing process of the branched-off partial quantity of the colder suctioned secondary gas with the warmer primary gas produces a gas mixture. The branched-off partial quantity of the secondary gas is adjusted or controlled with a closed loop with the aid of the first actuating element 11, which is driven by a controller 18, in such a way that the gas mixture resulting from the mixing process has a temperature in the line g from the claimed temperature range of 400° C. to 600° C.

The reducing agent is initially supplied to this cooled gas mixture with the aid of a supply device 5, in order to reduce the nitrogen oxide content in the gas mixture. At the point in time of the supply of the reducing agent, the gas mixture has a temperature of between 400° C. and 600° C., as claimed. The gas mixture enriched with the reducing agent is then supplied through the line g to a hot gas filter device 6 with catalytically coated candles, in particular to accelerate the Nox reduction and to separate dust from the gas mixture. After this filtering and catalysis of the gas mixture, it is suctioned through a line h with an induced draft blower 7.

In order to further reduce the temperature of the gas mixture and its preferably pressure prior to release into the surroundings, a second branch, also called line e for a branched-off part of the further part of the suctioned secondary gas, is optionally provided, which connects the secondary gas line d downstream of the filtering separator 9 with the line h for the gas mixture downstream of the hot gas filter 6. The connecting node point represents a further mixing device 17. The mixing process that takes place there results in a residual gas mixture in the line i. Analogous to the first branch b, a further actuating element 12, for example again in the form of a bypass valve, is arranged in the second branch e. Such further actuating element 12 is also advantageously adjusted/controlled with a closed loop with the aid of the controller 18 in such a way that the temperature of the residual gas mixture is cooled to a temperature of below 200° C., preferably to below 100° C.; see reference sign C in the FIGURE. At this point, the pressure level can also drop again based on the secondary gas supplied. A low pressure level and low temperature enable the design of the induced draft blower 7 for lower pressures and lower temperatures, making it cost-effective.

The residual gas mixture is released into the surroundings via the chimney at the outlet of the induced draft blower 7.

The key points of the method in accordance with the invention are outlined again below:

Reliable NOx reduction without additional heating of the primary gas and without installing a heat exchanger.

Cleaning, i.e. in particular dedusting, is effected separately for the primary gas and the secondary gas. This makes sense because the primary gas has a much higher dust load than the secondary gas. Accordingly, the filter devices provided for this purpose, i.e. the hot gas filter device 6 and the fabric filter, i.e. the filtering separator 9, can be used differently and in a cost-optimized manner in each case. In addition, the use of activated carbon can significantly reduce the amount of harmful dust. Separate treatment of the filtered dust from the primary gas and secondary gas makes sense because the dust in the primary gas has a high iron content. Joint disposal of the dusts, as is necessary upon a mixing process of primary gas and secondary gas, makes little sense based on the high iron content in the dust of the primary gas.

In the event that the catalytically coated ceramic filter elements/filter candles in the hot gas filter device 6 and the fabric filter 9 are contaminated with lead, for example, they can be replaced at low cost. This is significantly more cost-effective than completely replacing the hot gas filter device 6 or the fabric filter 9.

### LIST OF REFERENCE SIGNS

1 Metallurgical vessel
2 Post-combustion chamber
2.1 Cooling chamber
3 Hot gas cyclone
4 Actuating element
5 Supply device for reducing agent
6 Hot gas filter device
7 Induced draft blower
8 Auxiliary suction point, e.g. roof hood
9 Fabric filter=filtering separator
10 Secondary gas induced draft blower
11, 12 Actuating elements, for example bypass valves
13 Chimney
14 Mixing device, in particular nodes in the gas line network
17 Further mixing device
18 Controller
a Line for primary gas=primary gas branch
b Line for part of the suctioned secondary gas
C Line for further partial quantity of the suctioned secondary gas
d Line for cleaned part of the suctioned secondary gas
e Line for part of the other part of the suctioned secondary gas
f Line for residual secondary gas
g Line for gas mixture enriched with reducing agent
h Line for cleaned gas mixture
i Line for residual gas mixture
X Secondary gas line/branch
A 400° C.-1,000
B 400° C.-600° C.
C. <100° C.-200° C.

1.-22. (canceled)

23. A method for treating a primary gas from a vessel, comprising:
suctioning a secondary gas at an auxiliary suction point in surroundings of the vessel (1), wherein the secondary gas is colder than the primary gas;
controlled mixing of the primary gas after its exit the vessel with the secondary gas to produce a gas mixture until the gas mixture has cooled to a target temperature in a temperature range from 400° C. to 600° C.;
supplying a reducing agent to the gas mixture for reducing NOx contained in the primary gas within the gas mixture;
suctioning the gas mixture, reduced by the NOx, with an induced draft blower (7); and
discharging the gas mixture through a chimney (13),
wherein the vessel is a metallurgical vessel in form of an electric arc furnace, a reduction furnace, or an induction furnace suitable for producing steel, ferrous alloys, or non-ferrous alloys,
wherein the controlled mixing of the primary gas to form the gas mixture is effected only with a branched-off part of the secondary gas, and
wherein the reducing the NOx is accelerated by passing the gas mixture enriched with the reducing agent past catalytically coated candles,
wherein a coating acts as a catalyst and the catalytically coated candles act as dust separators for cleaning the gas mixture.

24. The method according to claim 23,
wherein the controlled mixing of the primary gas with the secondary gas is effected in the form of an open-loop or closed-loop control,
wherein a partial quantity of the secondary gas supplied to the primary gas as cooling medium is adjusted or varied by an actuating element (11) in form of a bypass valve in such a way that the target temperature is set, and
wherein, if the controlled mixing is implemented as a closed-loop control, the partial quantity of the secondary gas is adjusted or varied in accordance with a difference between a temperature of the primary gas prior to the mixing and the target temperature.

25. The method according to claim 23, further comprising:
initially post-combusting the primary gas in a post-combustion chamber (2) after leaving the vessel (1) but prior to mixing with the secondary gas.

26. The method according to claim 25, further comprising
pre-cooling the primary gas after post-combusting to a temperature of 850° C. to 750° C. in a cooling chamber (2.1) prior to mixing with the secondary gas.

27. The method according to claim 23,
wherein the secondary gas has a temperature of 50° C.-80° C. prior to mixing with the primary gas.

28. The method according to claim 26, further comprising
passing the primary gas after pre-cooling through a hot gas cyclone (3) for separating coarse dust particles from the primary gas and for reducing a pressure of the primary gas.

29. The method according to claim 23, further comprising:
cleaning a further partial quantity of the secondary gas, which is not mixed with the primary gas, in a filtering separator (9) for reducing dust, and then
discharging a residual part of the secondary gas through the chimney (13).

30. The method according to claim 29, further comprising
using activated carbon to remove furans and dioxins during cleaning of the gas mixture and/or the further partial quantity of the secondary gas.

31. The method according to claim 29, further comprising:
supplying a part of the further partial quantity of the secondary gas after cleaning to the gas mixture after it has been NOx-reduced and dedusted, in order to further cool the gas mixture prior to entry into the induced draft blower (7) and the chimney (13).

32. The method according to claim 31,
wherein cooling gas mixture after it has been cleaned and NOx-reduced is effected by further mixing with the secondary gas after it has been cleaned with an open-loop or closed-loop control,
wherein the part of the further partial quantity of the secondary gas supplied to the gas mixture as a cooling medium is adjusted or varied with a further actuating element (12) in form of a further bypass valve in such a way that a further target temperature from a further target temperature range is set for the gas mixture, and
wherein, in case of closed-loop control, the further actuating element (12) is controlled according to a difference between a temperature of the gas mixture prior to the further mixing and the further target temperature.

33. The method according to claim 23,
wherein the reducing agent is urea or ammonia.

34. A device for treating a primary gas from a metallurgical vessel (1), comprising:
an auxiliary suction point (8) with a downstream secondary gas induced draft blower (10) for suctioning a colder secondary gas from surroundings of the metallurgical vessel (1);
a mixing device (14) for controlled mixing of the primary gas with the colder secondary gas to form a cooled gas mixture until the cooled gas mixture has cooled to a temperature in a temperature range from 400° C. to 600° C.;
a supply device (5) connected downstream of the mixing device (14) for supplying a reducing agent to the cooled gas mixture containing the primary gas for reducing NOx contained in the primary gas;
a chimney (13);
an induced draft blower (7) for suctioning the cooled gas mixture after being dedusted and NOx-reduced and for discharging a residual gas mixture through the chimney (13);
a control device (18) with an actuating element (11) for mixing the primary gas with only a partial quantity of the colder secondary gas;
a hot gas filter device (6), arranged downstream of the supply device (5), in form of a catalytic converter with catalytically coated candles for separating dust from the cooled gas mixture at the catalytically coated candles and for accelerated reducing the NOx in the cooled gas mixture when the cooled gas mixture flows around the catalytically coated candles; and
a post-combustion chamber (2) connected upstream of the mixing device (14) for post-combusting the primary gas from the metallurgical vessel (1).

35. A device for treating a primary gas, comprising:
a vessel (1) from which the primary gas exits, the vessel being an electric arc furnace, a reduction furnace, or an induction furnace, and the vessel being suitable for producing steel, ferrous alloys, or non-ferrous metal alloys;
an auxiliary suction point (8) with a downstream secondary gas induced draft blower (10) for suctioning a colder secondary gas from surroundings of the vessel (1);
a mixing device (14) for controlled mixing of the primary gas with the colder secondary gas to form a cooled gas mixture until the gas mixture has cooled to a temperature in a temperature range from 400° C. to 600° C.;
a supply device (5) connected downstream of the mixing device (14) for supplying a reducing agent to the cooled gas mixture containing the primary gas for reducing NOx contained in the primary gas;
a chimney (13);
an induced draft blower (7) for suctioning the cooled gas mixture, after it has been dedusted and NOx-reduced, and for discharging a residual gas mixture through the chimney (13);
a control device (18) with an actuating element (11) for mixing the primary gas with only a partial quantity of the colder secondary gas; and
a hot gas filter device (6) arranged downstream of the supply device (5) in form of a catalytic converter with catalytically coated candles for separating dust from the cooled gas mixture at the catalytically coated candles and for accelerated reducing the NOx in the cooled gas mixture when the cooled gas mixture flows around the catalytically coated candles.

36. The device according to claim 35, further comprising
a post-combustion chamber (2) connected upstream of the mixing device (14) for post-combusting the primary gas from the vessel (1).

37. The device according to claim 36, further comprising
a cooling chamber (2.1) connected downstream of the post-combustion chamber (2) for pre-cooling the post-combusted primary gas to a temperature of 850° C. to 750° C.

38. The device according to claim 37, further comprising
a hot gas cyclone (3) connected downstream of the cooling chamber (2.1) for separating coarse dust particles from the primary gas upstream of the mixing device (14).

39. The device according to claim 35, further comprising
a fabric filter (9) for separating dust from a further part of the secondary gas.

40. The device according to claim 39, further comprising
a further mixing device (17) for mixing the gas mixture filtered by the hot gas filter device (6) with a part of the further part of the secondary gas; and
a further actuating element (12) connected to the controller (18), for controlling the part of the further part of the secondary gas supplied to the gas mixture in such a way that a further gas mixture produced thereby is cooled to a desired temperature before it is expelled through the chimney (13).
